(19) United States
(12) Patent Application Publication
(10) Pub. No.: US 2026/0157288 A1
(43) Pub. Date: Jun. 11, 2026

(54) GREENHOUSE CULTIVATION METHOD FOR MOREL (MORCHELLA Spp.) USING LIQUID SPAWN

(71) Applicant: Qinghai University, Xining (CN)

(72) Inventors: Qianhan SHANG, Xining (CN); Wei SA, Xining (CN); Jian LIANG, Xining (CN)

(73) Assignee: Qinghai University, Xining (CN)

(21) Appl. No.: 19/183,582

(22) Filed: Apr. 18, 2025

(30) Foreign Application Priority Data
Aug. 9, 2024 (CN) 202411090879.3

(51) Int. Cl. A01G 18/50; A01G 9/14; A01G 18/22; A01G 18/40; A01G 18/64; A01G 18/69; A01G 18/70

(52) U.S. Cl. CPC A01G 18/50; A01G 18/20; A01G 18/40; A01G 18/70

(57) ABSTRACT

The present disclosure provides a greenhouse cultivation method for morel using liquid spawn, which specifically includes the following steps: step 1, preparing of culture medium and exogenous nutrient bags; step 2, purifying of spawn; step 3, preparing the purified spawn into liquid spawn; step 4, spreading the liquid spawn evenly over the raised beds; step 5, performing management during growth period; and step 6, harvesting morels when the total length of fruiting bodies reaches 12-14 cm with the pileus length of 7-9 cm. This liquid spawn disclosure demonstrates three key technical advantages in shortened cultivation cycle (7 d vs 20+d for solid spawn), easier sowing through spraying and lower cultivation cost compared to solid spawns. Yields can achieve over 200 kg/mu, and the facility-based greenhouse enables two cultivation seasons annually in the plateau area.

### INCORPORATION BY REFERENCE

This application claims priority to China Patent Application No 202411090879.3 filed 9 Aug. 2024, the contents of which are hereby incorporated by reference in their entirety.

### TECHNICAL FIELD

The present disclosure relates to the technical field of morel cultivation, and in particular, to a greenhouse cultivation method for Morchella spp. using liquid spawn.

### BACKGROUND

The unique climatic conditions and ecosystem of the plateau have nurtured rich biodiversity, including abundant wild Morchella resources. Morchella spp., known for their distinctive flavor, tender texture, and richness in nutrients and bioactive compounds, hold extremely high medicinal and culinary value, making them highly sought after globally.

Morel has been produced commercially for over a decade, with the industry rapidly expanding in scale and development. The cultivation area and yield of morels have been continuously increasing, and the industry has reached an initial scale of development. Except for a few cultivation models such as vertical cultivation in factories and forest-understory bionic cultivation, artificial cultivation of morels primarily employs facility-based greenhouse cultivation methods. Moreover, benefiting from the unique cool climate in the plateau area, this approach enables two cropping seasons annually.

Current cultivation technology for morels primarily relies on solid substrate bags (SSBs). These SSB matrices primarily consist of wheat, sawdust, corn cobs, supplemented with additional nutritional additives. However, this method faces dual critical challenges: (1) high production costs associated with SSB preparation and (2) excessive wheat consumption, driving an urgent need for grain-saving technological breakthroughs in morel cultivation. Liquid spawn addresses these issues through three key technical advantages in shortened cultivation cycles (7 d vs. 20+d for solid spawn), simplified sowing via spraying and reduced cultivation costs. Nevertheless, direct application of liquid spawn in agricultural practices remains undocumented, highlighting a critical gap between research and implementation.

Therefore, developing a greenhouse cultivation method utilizing liquid spawn technology for Morchella spp. has become an urgent agricultural research priority.

### SUMMARY

In order to solve the above issue, the present disclosure provides a greenhouse cultivation method for Morchella spp. using liquid spawn, which specifically includes the following steps:

### Step 1: Preparation of Culture Medium

Mix potatoes, glucose, agar and water in a ratio of 20 g: 2 g: 2 g: 100 mL, sterilize at a temperature of 121° C. under a pressure of 103 kPa for 20 min, and then cool to obtain a PDA (Potato Dextrose Agar) culture medium. Preferably, pour the medium into Petri dishes for solid culture.

Mix peptone, yeast extract powder, MgSO₄·7H₂O, KH₂PO₄, K₂HPO₄, glucose and distilled water in a ratio of 2 g: 1 g: 0.5 g: 0.5 g: 1 g: 20 g: 1 L, sterilize at the temperature of 121° C. under the pressure of 103 kPa for 20 min, and then cool to obtain a CYM (Complete Yeast Medium) liquid culture medium. Alternatively, mix potatoes, glucose and water in a ratio of 200 g: 20 g: 1 L, sterilize at the temperature of 121° C. under the pressure of 103 kPa for 20 min, and cool to obtain a PDB (Potato Dextrose Broth) medium.

Mix wheat, rape straw, humus soil, corn cobs and lime in a mass ratio of 50:30:10:9:1. Adjust moisture by spraying water to 60-65%. Fill the mixture into polypropylene mushroom cultivation bags (size: 12 cm×24 cm). Sterilize under 121° C. and 103 kPa for 3 h, then cool to obtain exogenous nutrient bags. Preferably, 3 d before preparing the exogenous nutrient bags, soak the wheat in water at 25° C. for 16-20 h, then mix it with rape straw and corn cobs, moisten, and conduct pile fermentation. After fermentation, mix with other materials.

### Step 2: Purification of Spawn

Inoculate the morel mother spawn onto the PDA medium, seal the plate, and incubate in dark conditions at 20° C. for 5 d. Select an uncontaminated PDA culture plate, and use a sterile hole puncher to remove a hyphal plug with a diameter of 9 mm. Transfer the plug to a fresh PDA medium, seal, and re-incubate under identical conditions (dark, 20° C., 5 d).

### Step 3: Preparation of Liquid Spawn

Select an uncontaminated PDA culture plate when the mycelia have fully colonized the PDA culture plate, use a sterile hole puncher to remove 20 hyphal plugs from each PDA medium, inoculate them into Erlenmeyer flasks containing CYM liquid culture medium, seal the flasks, and incubate at a constant temperature of 20° C. with shaking at 160 rpm, and obtain a liquid spawn when the mycelia have fully colonized the CYM liquid culture Erlenmeyer flask.

Alternatively, select an uncontaminated PDA culture plate when the mycelia have fully colonized the PDA culture plate, use a sterile hole puncher to remove 20 hyphal plugs from each PDA medium, inoculate them into PDB culture Erlenmeyer flasks, seal, incubate at a constant temperature of 20° C. with shaking at 160 rpm, and obtain a liquid spawn when the mycelia have fully colonized the PDB culture Erlenmeyer flask.

Preferably, during the preparation of the liquid spawn, mix the prepared liquid spawn with the liquid culture medium in a volume ratio of 1:10, seal the flasks, incubate at a constant temperature of 20° C. with shaking at 160 rpm, and obtain a new liquid spawn when the mycelia have fully colonized the liquid culture medium.

### Step 4: Sowing

Sowing time: for spring cultivation, carry out sowing when the soil temperature is ≤15° C. and the air temperature is ≤20° C. Generally, carry out sowing from early February to mid-March.

For autumn cultivation, carry out sowing when the temperature in the greenhouse is >0° C. Generally, carry out sowing from mid-to-late October to mid-December.

30 d before sowing, prepare the soil by cleaning and removing debris within the greenhouse, eliminating residual agricultural waste and impurities from the soil, and maintaining a clean and tidy greenhouse environment. After 10-15 d of preparation, raise the outer layer of greenhouse cotton insulation to the roof with a roller shutter machine, while keeping the inner plastic film tightly sealed. This solarization method utilizes intense sunlight exposure and high-temperature enclosure to sterilize the soil surface, effectively eliminating pathogens and pest insects. Then, apply quicklime into the soil in an amount of 50-100 kg/mu and rotary till the surface layer to a depth of 20-30 cm, and irrigate until the soil moisture content reaches 22-28%; after 7-15 d, when the soil surface becomes slightly moist, till the topsoil again to a depth of 15-20 cm and form raised beds. Construct beds with a width of 0.8-1.2 meters and a height of 10-15 cm, and leave 30 cm wide walkways between adjacent beds.

Carry out sowing when the soil pH in the greenhouse is between 6.5 and 7.5. Dilute the liquid spawn with water at a ratio of 5-10 times and evenly spread it over the raised beds in an amount of 140-200 L/mu, and then irrigate the soil until its moisture content reaches 20-25%. After sowing for 7-10 d, place exogenous nutrient bags.

Unlike solid spawn cultivation, liquid spawn cultivation rarely or never produces “mycelial mat”.

Preferably, after sowing, rake the soil to a depth of 2-3 cm to cover the spawn.

Preferably, use 1500 exogenous nutrient bags per mu, arrange alternately on the raised beds at 20-30 cm intervals between each bag. Most preferably, before placement, use sterilized tools to make two slits on one side of each bag or punch 9-18 holes in a row. Position the slits or openings downward and press the bags firmly onto the raised bed surface gently to ensure closely contact between morel mycelia and exogenous nutrient bags. After nutrient bags placement, maintain the same air and soil temperature/humidity controls as during the mycelial growth phase. If any contamination by pathogenic microbes is detected in the nutrient bags, promptly remove the contaminated bags from the greenhouse to prevent microbial spread and disease escalation.

### Step 5: Management During Growth Period

Management during spawn-running period: maintain air temperature ≤2020 C., air relative humidity at 80-95%, soil temperature ≤15° C., and soil moisture content at 15-25%.

Preferably, the greenhouse cotton insulation should keep closed for most of the time during the spawn-running period. If the air temperature and soil temperature in the greenhouse are excessively high, it is optional to open the cotton insulation for ventilation and cooling in the morning and evening before the sun rises or after the sun sets. The ventilation time should not be too long to avoid a sudden drop in relative humidity in the air, making it difficult to retain moisture. When the outside temperature is low, the cotton insulation can be opened at noon to increase the temperature, making sure to open the cotton insulation to the shade net level to avoid direct sunlight on the greenhouse. When the temperature and humidity are suitable, ventilate the greenhouse every 2-3 d at appropriate times.

Management during mushroom induction period: maintain air humidity at 85-95%, and soil water content at 25-30%; and carry out water stimulation after morels has been sown for 40-80 d and when the soil temperature is maintained at 8-15° C. Primordia become visible after 5-10 d of closed greenhouse management.

Preferably, the water stimulation refers to sprinkler irrigation until soil moisture content reaches 22-28%.

Management from primordium differentiation to young mushroom stage: maintain the air temperature at 4-18° C. and the relative air humidity >85%.

Management during fruit body growth period: after the formation of 1.5-3 cm small mushrooms, maintain air temperature at 10-18° C., air relative humidity at 80-90%, and soil moisture content at 20-25%;

During fruiting body maturation stage, maintain air relative humidity at 70-85%, and reduce soil moisture content to 18-22%.

Step 6: harvest morels when the total length of fruiting bodies reaches 12-14 cm with the pileus length of 7-9 cm.

The present disclosure also includes pest and disease control, with less or no application of chemical pesticides and killing agents, etc. For fungal diseases, strengthen preliminary soil sterilization treatment. If any contaminated nutrient bags are detected, immediately remove them from the greenhouse and spread quicklime around contaminated areas. If fruiting bodies are contaminated by molds, promptly remove fungal-infected fruiting bodies. For Pezizomycotina caused diseases, reduce continuous cropping years of morels in the greenhouse, and implement crops rotation with other agricultural plants after two years of cultivation. Deploy mouse traps, sticky mouse boards and rodenticides in the greenhouse. Quicklime should be spread in places where slugs frequently appear. If there are signs of extensive slug activity, metaldehyde bait should be spread for trapping and extermination. For flying insects such as mushroom gnats and flies, they can be trapped and exterminated by hanging sticky insect boards and insect-attracting lights.

The present disclosure has the following advantages:
(1) Cost savings: at present, the cultivation of morels is mainly based on solid substrate spawn, with wheat as the main raw material. The typical spawn amount is 125-150 kg/mu, whereas the liquid spawn amount is 140-200 L/mu. The cost of solid wheat-based spawn is about 3 RMB/kg, with additional auxiliary materials costing 1 RMB/kg, resulting in a minimum spawn cost of over 500 RMB per mu. The cost of the liquid spawn is only 1 RMB/L, with a minimum spawn cost of 140 RMB per mu, reducing costs by more than 70% compared to solid spawn, greatly saving production costs and improving economic benefits.
(2) Time savings: the production of solid morels spawn generally requires more than 20 d, while the liquid spawn generally only takes 7 d, saving 65% of the time compared to the solid spawn. This greatly shortens the spawn production time and improves production efficiency.

### DETAILED DESCRIPTION OF EMBODIMENTS

The technical solutions in the embodiments of the present disclosure are described clearly and completely below. Obviously, the described embodiments are only part of the embodiments of the present disclosure, rather than all the embodiments. Based on the embodiments of the present disclosure, all other embodiments obtained by a person of ordinary skill in the art without making any creative work shall fall within the scope of protection of the present disclosure.

From 2021 to 2023, the experimental morels cultivation of liquid spawn was carried out continuously in the facility greenhouses of the Academy of Agriculture and Forestry of Qinghai University and the National Plateau Modern Agricultural Science and Technology Demonstration District in Huzhu County (Examples 1-2).

### Example 1

### Step 1: Preparation of Culture Medium

Preparation of PDA medium: dilute 20 g of glucose, 200 g of potatoes and 20 g of agar with distilled water to 1 L, sterilize the obtained mixture under high pressure at 121° C. for 20 min, then cool to obtain a PDA culture medium, and pour the medium into Petri dishes to prepare culture plate.

CYM liquid medium: dilute 2 g of peptone, 1 g of yeast extract powder, 0.5 g of MgSO₄·7H₂O, 0.5 g of KH₂PO₄, 1 g of K₂HPO₄ and 20 g of glucose with distilled water to 1 L, sterilize the obtained mixture under high pressure at 121° C. for 20 min, and cool to obtain a CYM liquid medium.

Exogenous nutrition bags: mix wheat, rape straw, humus soil, corn cobs and lime in a mass ratio of 50:30:10:9:1, adjust moisture by spraying water to 60-65%, fill the mixture into polypropylene mushroom cultivation bags (size: 12 cm×24 cm), and sterilize at 100° C. under normal pressure for 10-36 h or at 121° C. and 103 kPa for 3 h to obtain exogenous nutrient bags.

3d before preparing the exogenous nutrient bags, soak the wheat in water at 25° C. for 16-20 h, then mix with rape straw and corn cobs, moisten and conduct pile fermentation, and mix with other materials after fermentation.

### Step 2: Purification of Spawn

In a laminar flow hood, transfer the morel mother spawn onto the PDA culture plate. After sealing, incubate these plates in dark conditions at a constant temperature of 20° C. for 5 d, observe the growth and contamination of mycelia daily, and select culture plates with good growth while without pigment and contamination. Use a sterile hole puncher to remove a hyphal plug with a diameter of 9 mm, transfer the plug to the center of new PDA culture plate, seal the new dishes and re-incubate under identical conditions (dark, 20° C., 5 d).

### Step 3: Preparation of Liquid Spawn

Select the uncontaminated PDA culture plate when the mycelia have fully colonized the PDA culture plates, use a sterile hole puncher to remove 20 hyphal plugs from each PDA culture plate, inoculate them into the CYM liquid culture medium, with 1 L of which contained in a 2L conical flask, seal the conical flask and incubate at a constant temperature of 20° C. with shaking at 160 rpm for 5-7 d, and obtain a liquid spawn when a large amount of spherical or flocculent mycelia have fully colonized the culture liquid.

### Step 4: Sowing

Select a greenhouse with good thermal insulation and equipped with complete facilities including roller shutter machines, film rolling machines, irrigation systems, ventilation systems, and water/electricity facilities, maintaining temperature above 0 ° C. Along the greenhouse frame, hang 6-needle sunshade nets at a height of 1.6 m from the ground on the sun-exposed interior surfaces. The soil within the greenhouse should be free from apparent soil-borne diseases, and the previous crop must have grown well without continuous cropping diseases. Select soil with good aeration and water retention properties, free from contamination sources such as pesticides, fungicides or herbicides-preferably sandy loam, loam or chestnut soil with pH between 6.5-7.5.

30 d before morel sowing, prepare the soil by cleaning and removing debris within the greenhouse, eliminating residual agricultural waste and impurities from the soil, and maintaining the greenhouse clean and tidy. After 10 d of preparation, raise the outer layer of the greenhouse cotton insulation to the roof with a roller shutter machine, and tightly close the inner layer of plastic film. This solarization method utilizes intense sunlight exposure and high-temperature enclosure to sterilize the soil surface, effectively eliminating pathogens and pest insects. Then, apply quicklime at 100 kg/mu, rotary till the soil surface to a depth of 30 cm, and flood-irrigate thoroughly the soil; after 7 d, when the soil surface slightly moist for operation, shallowly till the soil surface to a depth of 20 cm and to make raised beds. Construct beds with a width of 1 m and a height of 15 cm, and leave a 30 cm wide working path between adjacent beds.

When sowing, dilute the liquid spawn with water at a ratio of 10 times and evenly spread it over the raised bed surface in an amount of 150 L/mu, rake the soil by 2 cm to cover the liquid spawn, and then irrigate the soil until its moisture content reaches 20-25%. After 7 d of sowing, place the exogenous nutrient bags.

### Step 5: Management During Growth Period

Management during spawn-running period: maintain air temperature ≤20° C., air relative humidity at 80-95%, soil temperature ≤15° C., and soil moisture content at 15-25%.

Management during mushroom induction period: maintain the air humidity at 85-95%, and the soil water content at 25-30%; At 50 d after morel sowing, when the soil temperature maintained between 8-15° C., apply water stimulation by irrigating until soil water content reaches 22-28%. Primordia become visible after 5 d of closed greenhouse management.

Management from primordium differentiation to young mushroom stage:
maintain the air temperature at 4-18° C. and the relative air humidity >85%.

Management during fruit body growth period: after the formation of 1.5 cm small mushrooms, maintain the air temperature at 10-18° C., the air relative humidity at 80-90%, and the soil moisture content at 20-25%.

During fruiting body maturation stage, the air relative humidity was 70-85%, and the soil moisture content was reduced to 18-22%.

At step 6, harvest morels when the total length of fruiting bodies reaches 12-14 cm with the pileus length of 7-9 cm. When harvesting, hold the stipe with one hand and use a non-metallic blade with the other hand to cut horizontally from the base of the stipe near the ground, gently put the harvested fruiting bodies into containers, then sort them according to quality grades. Fresh products can be sold in time, or preserved through sun-drying or dehydration. A yield of exceeding 200 kg/mu of morels can be achieved, and the facility-based greenhouse enables two cropping seasons annually in the plateau area.

### Example 2

### Step 1: Preparation of Culture Medium

Preparation of PDA medium: dilute 20 g of glucose, 200 g of potatoes and 20 g of agar with distilled water to 1 L, sterilize the obtained mixture under high pressure at 121° C. for 20 min, then cool to obtain a PDA medium, and pour the medium into Petri dishes to prepare culture plate.

PDB medium: dilute 200 g of potatoes and 20 g of glucose with distilled water to 1 L, sterilize the obtained mixture under high pressure at 121° C. for 20 min, and cool to obtain a PDB medium.

Exogenous nutrition bag: mix wheat, rape straw, humus soil, corn cobs and lime in a mass ratio of 50:30:10:9:1, adjust the moisture by spraying water to 60-65%, fill the mixture into polypropylene mushroom cultivation bags (size: 12 cm×24 cm), and sterilize at 100° C. under normal pressure for 10-36 h or at 121° C. and 103 kPa for 3 h to obtain exogenous nutrient bags.

3 d before preparing the exogenous nutrient bags, soak the wheat in water at 25° C. for 16-20 h, then mix with rape straw and corn cobs, moisten and conduct pile fermentation, and mix with other materials after fermentation.

### Step 2: Purification of Spawn

In a laminar flow hood, transfer the morel mother spawn onto the PDA culture plate. After sealing, incubate these plates in dark conditions at a constant temperature of 20° C. for 5 d, observe the growth and contamination of mycelia daily, and select culture plates with good growth while without pigment and contamination. Use a sterile hole puncher to remove a hyphal plug with a diameter of 9 mm, transfer the plug to the center of new PDA culture plates, seal the new dishes and re-incubate under identical conditions (dark, 20° C., 5 d).

### Step 3: Preparation of Liquid Spawn

Select the uncontaminated PDA culture plate when the mycelia have fully colonized the PDA culture plates, use a sterile hole puncher to remove 20 hyphal plugs from each PDA culture plate, inoculate them into the PDB medium, with 1 L of which contained in a 2 L conical flask, seal the conical flask and incubate at a constant temperature of 20° C. with shaking at 160 rpm for 5-7 d, and obtain the liquid spawn when a large amount of spherical or flocculent mycelia have fully colonized the culture liquid.

### Step 4: Sowing

Select a greenhouse with good thermal insulation and equipped with complete facilities including roller shutters machines, film rolling machines, irrigation systems, ventilation systems, and water/electricity facilities, and maintain temperature above 0 ° C. Along the frame of the greenhouse, hang 6-needle sunshade nets at a height of 1.6 m from the ground on the sun-exposed interior surfaces. The soil within the greenhouse should be free from obvious soil-borne diseases, and the previous crop must have grown well without continuous cropping diseases. Select soil with good aeration and water retention properties, free from contamination sources such as pesticides, fungicides or herbicides-preferably sandy loam, loam or chestnut soil with pH between 6.5-7.5.

30 d before morel sowing, prepare the soil by cleaning and removing debris within the greenhouse, eliminating residual agricultural waste and impurities from the soil, and maintaining the greenhouse clean and tidy. After 10 d of preparation, raise the outer layer of the greenhouse cotton insulation to the roof with a roller shutter machine, and tightly close the inner layer of plastic film. This solarization method utilizes intense sunlight exposure and high-temperature enclosure to sterilize the soil surface, effectively eliminating pathogens and pest insects. Then, apply quicklime at 100 kg/mu, rotary till the soil surface to a depth of 30 cm, and flood-irrigate thoroughly the soil; after 7 d, when the soil surface slightly moist for operation, shallowly till the soil surface to a depth of 20 cm and to make raised beds. Construct beds with a width of 1 m and a height of 15 cm, and leave a 30 cm wide working path between adjacent beds.

When sowing, diluting the liquid spawn with water at a ratio of 10 times and evenly spread it over the raised bed surface in an amount of 200 L/mu, rake the soil by 2 cm to cover the liquid spawn, and then irrigate the soil until its moisture content reaches 20-25%. After 7 d of sowing, place the exogenous nutrient bags.

### Step 5, Management During Growth Period

Management during spawn-running period: maintain an air temperature ≤20° C., an air relative humidity at 80-95%, a soil temperature ≤15° C, and a soil moisture content at 15-25%.

Management during mushroom induction period: maintain the air humidity at 85-95%, and the soil moisture content at 25-30%; At 50 d after morel sowing, when the soil temperature maintained at 8-15° C., initiate water stimulation via sprinkler irrigation until water accumulated between the raised beds and was parallel to the raised bed surface, and the soil moisture content reached 22-28%. Primordia become visible after 5 d of closed greenhouse management.

Management from primordium differentiation to young mushroom stage: maintain the air temperature at 4-18° C. and the relative air humidity >85%.

Management during fruit body growth period: after the formation of 1.5 cm small mushrooms, maintain the air temperature at 10-18° C., the air relative humidity at 80-90%, and the soil moisture content at 20-25%.

During fruiting body maturation stage, the air relative humidity was 70-85%, and the soil moisture content was reduced to 18-22%.

At step 6, harvest morels when the total length of fruiting bodies reaches 12-14 cm with the pileus length of 7-9 cm. When harvesting, hold the stipe with one hand and use a non-metallic blade with the other hand to cut horizontally from the base of the stipe near the ground, gently put the harvested fruiting bodies into containers, then sort them according to quality grades. Fresh products could be sold in time, or preserved through sun-drying or dehydration. A yield of exceeding 200 kg/mu of morels could be achieved, and the facility-based greenhouse enables two cropping seasons annually in the plateau area.

The above description of the disclosed embodiments enables those skilled in the art to implement or use the present disclosure. Various modifications to these embodiments will be readily apparent to those skilled in the art, and the general principles defined herein may be implemented in other embodiments without departing from the spirit or scope of the invention. Thus, the present disclosure will not be limited to the embodiments shown herein but is to be accorded the widest scope consistent with the principles and novel features disclosed herein.

What is claimed is:

1. A greenhouse cultivation method for morels using liquid spawn, comprising the following steps:
step 1: preparing culture medium
preparing PDA (Potato Dextrose Agar) culture medium, liquid culture medium and exogenous nutrient bags;
step 2: purifying spawn
inoculating morel mother spawn onto the PDA medium for activation cultivation in a dark condition. After a period of time, selecting uncontaminated PDA medium and transferring the mycelia to a fresh PDA medium for further purification cultivation in the dark environment;
step 3: preparing liquid spawn
selecting the uncontaminated PDA medium when the mycelia have fully colonized the PDA medium, transferring the mycelia from the uncontaminated PDA medium into CYM (Complete Yeast Medium) liquid medium for cultivation, and obtaining the liquid spawn when the mycelia fully colonized the CYM liquid medium;
step 4: sowing
plowing soil and making cultivation beds when the greenhouse temperature ranges from above 0° C. to 20° C. (0° C. <temperature ≤20° C.) and the soil pH is between 6.5-7.5, diluting the liquid spawn with water and evenly spreading it on the raised beds surface in an amount of 140-200L /mu, then irrigating until the soil moisture content reaches 20-25%, 7-10 d after sowing, placing exogenous nutrient bags in a way that allows the mycelia contact them;
step 5, performing management during growth period
management during spawn-running period: maintaining an air temperature ≤20° C., an air relative humidity at 80-95%, a soil temperature ≤15° C., and a soil moisture content at 15-25%;
management during mushroom induction period: maintaining an air humidity at 85-95%, and the soil moisture content at 25-30%; 40-80 d after morel sowing, when the soil temperature maintained between 8-15° C., applying water stimulation;
management from primordium differentiation to young mushroom stage: maintaining the air temperature at 4-18° C. and the relative air humidity >85%;
management during fruit body growth period: after the formation of 1.5-3 cm small mushrooms, maintaining the air temperature at 10-18° C., the air relative humidity at 80-90%, and the soil moisture content at 20-25%;
management during fruiting body maturation stage: maintaining the air relative humidity at 70-85%, and reducing the soil moisture content to 18-22%;
step 6, harvesting morels when the total length of fruiting bodies reaches 12-14 cm with the pileus length of 7-9 cm.

2. The greenhouse cultivation method for morels using the liquid spawn according to claim 1, wherein a method for preparing the PDA medium described in Step 1 is as follows: mix potatoes, glucose, agar and water in a ratio of 20 g: 2 g: 2 g: 100 mL to obtain a mixture, sterilize the mixture at a temperature of 121° C. under a pressure of 103 kPa for 20 min, and cool to obtain the PDA medium.

3. The greenhouse cultivation method for morels using the liquid spawn according to claim 1, wherein the liquid culture medium described in step 1 is a CYM liquid culture medium or a PDB culture medium;
a method for preparing the CYM culture medium is as follows: mix peptone, yeast extract powder, MgSO₄·7H₂O, KH₂PO₄, K₂HPO₄, glucose and distilled water in a ratio of 2 g: 1 g: 0.5 g: 0.5 g: 1 g: 20 g: 1 L to obtain a mixture, and sterilize the mixture at the temperature of 121° C. under the pressure of 103 kPa for 20 min, and cool to obtain the CYM liquid culture medium;
a method for preparing the PDB culture medium is as follows: mix potatoes, glucose and water in a ratio of 200 g: 20 g: 1 L to obtain a mixture, and sterilize the mixture at the temperature of 121° C. under the pressure of 103 kPa for 20 min, and cool to obtain the PDB culture medium.

4. The greenhouse cultivation method for morels using the liquid spawn according to claim 1, wherein a method for preparing the exogenous nutrient bags described in step 1 is as follows: mix wheat, rape straw, humus soil, corn cobs and lime in a mass ratio of 50:30:10:9:1 to obtain a mixture, moisten the mixture by spraying water to a moisture content of 60-65%, and fill the mixture into bags and sterilize the bags at the temperature of 121° C. under the pressure of 103 kPa for 3 h to obtain the exogenous nutrient bags.

5. The greenhouse cultivation method for morels using the liquid spawn according to claim 4, wherein 3 d before preparing the exogenous nutrient bags, wheat is soaked in water at 25° C. for 16-20 h, then mixed it with rape straw and corn cobs, and moistened for pile fermentation. After fermentation, mixed with other materials.

6. The greenhouse cultivation method for morels using the liquid spawn according to claim 1, wherein step 3 further comprises mixing the prepared liquid spawn with the liquid culture medium in a volume ratio of 1:10, sealing, and incubating at a constant temperature of 20° C. with shaking at 160 rpm until the mycelia have fully colonized the liquid culture medium to obtain a new liquid spawn.

7. The greenhouse cultivation method for morels using the liquid spawn according to claim 1, wherein, in step 4, 30 d before sowing, cleaning and removing debris within the greenhouse, eliminating residual agricultural waste and impurities from the soil, quicklime is applied into the soil in an amount of 50-100 kg/mu after cleaning 10-15 d, the soil surface is rotary tilled to a depth of 20-30 cm, irrigated until the soil moisture content reaches 22-28%, and then the greenhouse is closed for heat treatment; after 7-15 d, the soil surface is plowed to a depth of 15-20 cm to make raised beds, wherein the raised beds have a width of 0.8-1.2 m and a height of 10-15 cm, with a 30 cm wide walkways between adjacent beds.

8. The greenhouse cultivation method for morels using the liquid spawn according to claim 1, wherein after sowing in step 4, the soil is raked to a depth of 2-3 cm to cover the spawn.

9. The greenhouse cultivation method for morels using the liquid spawn according to claim 1, wherein the amount of exogenous nutrient bags described in step 4 is 1500 bags/mu, and arranged alternately on the raised bed surface at 20-30 cm intervals between each bag.
